(19) United States
(12) Patent Application Publication
(10) Pub. No.: US 2014/0223350 A1
(43) Pub. Date: Aug. 7, 2014

(54) USER INTERFACE

(71) Applicant: Neutrino Concepts Ltd, Longbridge (GB)

(72) Inventor: Jonathan Woodward, Longbridge (GB)

(73) Assignee: Neutrino Concepts Ltd, Longbridge (GB)

(21) Appl. No.: 14/170,973

(22) Filed: Feb. 3, 2014

(30) Foreign Application Priority Data
Feb. 3, 2013 (GB) 130188.2

(51) Int. Cl. G06F 3/0481; G06F 3/01; G06F 3/0484

(52) U.S. Cl. CPC G06F 3/04812; G06F 3/04842; G06F 3/017
USPC 715/771

(57) ABSTRACT

A computer implemented method comprising the steps of: detecting a user selection of a plurality of visual representations of data associated with at least partially different sources of data, enabling a user to move the location of at least one of the selected visual representation of data on a display, and thereby to move an active area associated with it, generating a new visual representation of data, and displaying the new visual representation of data, wherein the step of generating is performed after a user has moved at least one of the selected visual representations of data, and an active area associated with it, so that the moved active area overlaps an active area associated with another of the selected visual representations; the step of generating is at least partially in response to the overlap of active areas of selected visual representations; and the new visual representation of data is based on/represents data represented/displayed in the selected visual representations of data which have overlapping active areas.

### BACKGROUND

The invention relates to an apparatus and method of manipulating, and generating displays of, data.

The ability to search and retrieve data relevant to specific queries is important for understanding and analysis of information that has been collected and stored in data warehouses. The ability to extract appropriate responses to queries from vast quantities of data relies on the use of suitable algorithms for returning results to a user.

It is known to provide charts containing responses to queries and to display these responses. The charts that are produced show data according to factors that define the data's relevance, however, should the user wish to further analyse results and make comparisons of particular aspects of data in direct response to viewing the results produced by the search algorithm, it is necessary for them to select those particular aspects of data and generate new displays. This requires a user to perform a series of burdensome and time consuming steps that inhibit the user from quickly and efficiently achieving desired results and consequently impacts on the ability of the user to make decisions and process data. Such inputs are also prone to user error and inaccuracies.

Typically a user wishing to combine data from two or more charts (often referred to as “merging” or “integrating” charts) must perform a number of steps separately for each selected chart in order to generate a series splitter for each of the charts which are associated with data that the user wishes to investigate further. A user input is required to select a first chart, then further user inputs are required to manually select desired series of data for that first chart. Each time a series of data is selected, it must then be assigned a further chart name requiring further user input. The process is repeated for each chart from which data that is required and the necessary data to be displayed is built. The user must then provide further inputs to select the data from the series chosen from each of the series splitters, and then to generate a combined chart at a further step.

The use of such a process for analysing data is inefficient and impedes a user's ability to access information in a seamless and intuitive manner. What is required is a way of reducing the burden upon a user such that they are able to more quickly and efficiently retrieve the data that they desire and generate displays/charts of the desired data.

### SUMMARY

In order to mitigate for at least some of the problems described above, according to an embodiment of the invention there is provided a computer implemented method comprising the steps of: detecting a user selection of a plurality of displays of data associated with at least partially different sources of data; enabling a user to move at least one of the selected displays of data and an active area associated with it until the active area associated with one of the selected displays of data overlaps an active area associated with another of the selected visual representation of data; and in response to moving at least one of the selected displays of data and an active area associated with it until the active area associated with one of the selected displays of data overlaps an active area associated with another of the selected visual representation of data, generating a new visual representation of data, wherein the new visual representation of data is based on information from the at least partially different sources of data associated with the plurality of overlapping selections of displays of data.

Further aspects and embodiments of the invention will become apparent from the appended claims, drawings and the detailed description.

### BRIEF DESCRIPTION OF THE FIGURES

FIG. 1 shows a computing apparatus according to an aspect of the invention;

FIG. 2a shows selection of charts on a display;

FIG. 2b shows movement of a selected chart on a display;

FIG. 2c shows a final position of a moved chart on a display

FIG. 4 is a flow chart of the method according to an aspect of the invention;

FIG. 3a shows two selected charts highlighted on a display;

FIG. 3b shows direction of movement of highlighted charts on a display;

FIG. 3c shows overlapping highlighted charts on a display;

FIG. 3d shows a selection window on a display;

FIG. 3e shows charts including a resultant integrated chart on a display;

FIG. 5a shows movement of charts that are not highlighted on a display;

FIG. 5b shows overlapping charts that are not highlighted on a display; and

FIG. 5c shows resultant positions of charts that are not highlighted on a display

### DETAILED DESCRIPTION

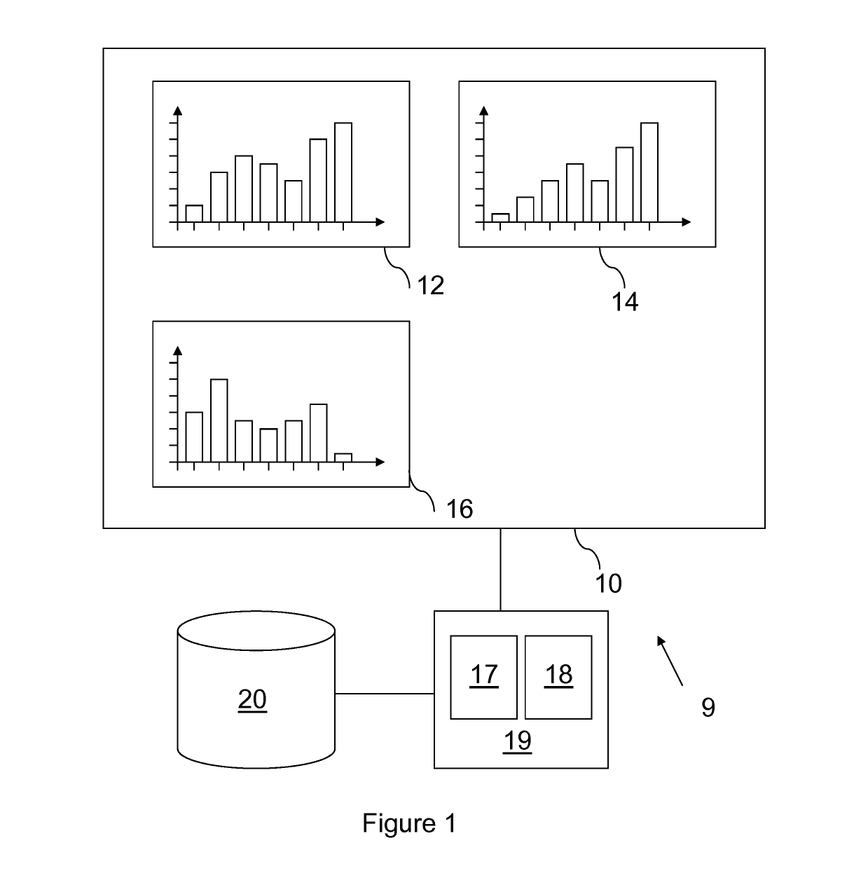

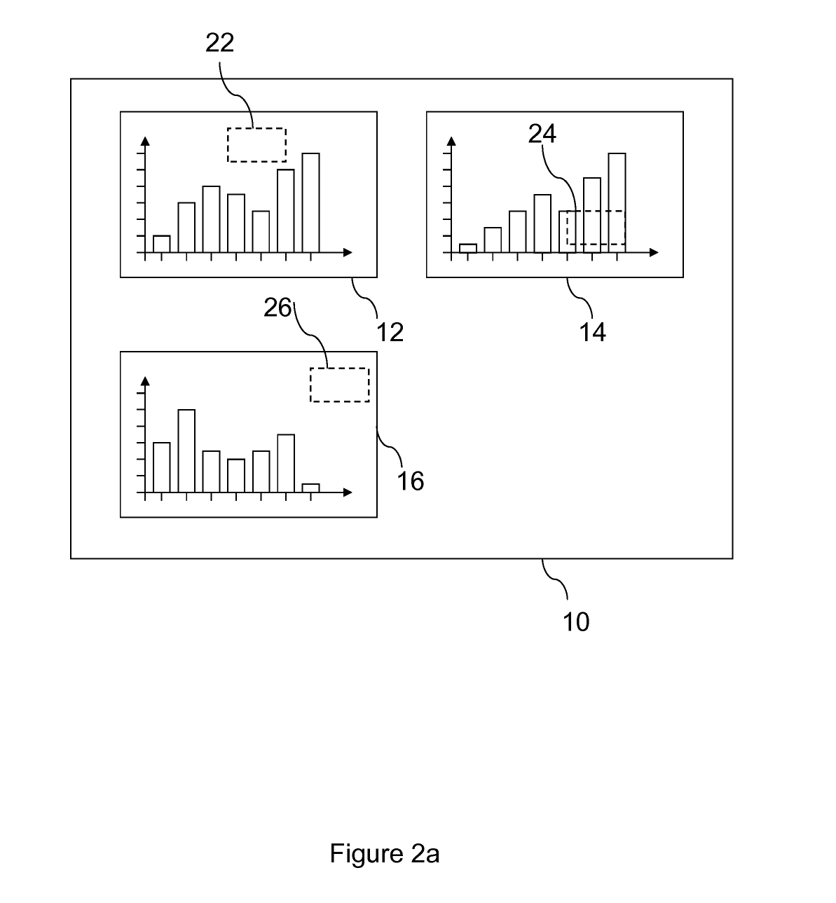

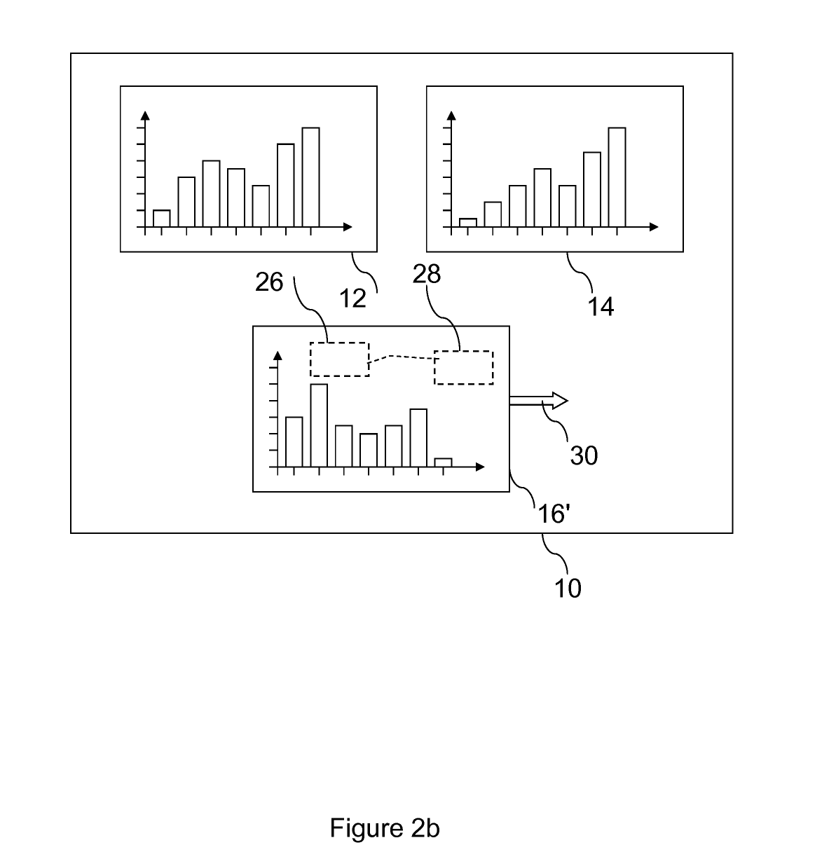

FIG. 1 shows a schematic of apparatus 9 which forms or can be used with embodiments of the invention. There is shown first display 10 coupled to a server/computer 19, which contains a processor 17 and RAM 18. The computer/ server 19 is coupled to a database 20. The database 20 may be a local or a remotely accessed database. The display 10 may be coupled to more than one database 20 via the computer or server 19. In further examples of the invention, the computer or server 19 is part of a network, which may be wired or wireless, from which data can be sourced for analysis and display by the computing apparatus 9. The apparatus may comprise one or more further displays (not shown).

The display 10 is preferably a touch screen display which enables input from a user who performs touch gestures on the display 10 and those gestures are detected and processed at the processor 17. The touch screen display can be a capacitive touch screen, allowing the user to input gestures using finger based gestures. Alternatively the touch screen may be a resistive touch screen. In further examples the display 10 is a not a touch screen and user input is performed with a mouse, trackball, touch pad, or other form of input that is detectable and can be processed via processor 17. Where a non-touch screen is used, preferably the user's inputs are captured by a motion sensor enabling gestures to be used. In further examples input to the processor 17 in response to what is viewed at the display 10 is made using a combination of input methods.

At display 10 of FIG. 1, the user interacts with the computer in a known manner. Results of queries of data are displayed at the display 10. In the example shown in FIG. 1 three charts 12, 14, 16, are displayed, though the number, and type, of charts displayed may vary. The charts 12, 14, 16 are displays based on analysis of data that is stored in a database 20 and generated for display by the processor 17. The charts 12, 14, 16 are produced in response to a query that has been submitted to search one or more databases 20 in a known manner. Charts can be used to show any information relating to content of a database. For example, the charts may show the number of sales of a product by a geographical region, or the number of sales of a product by day.

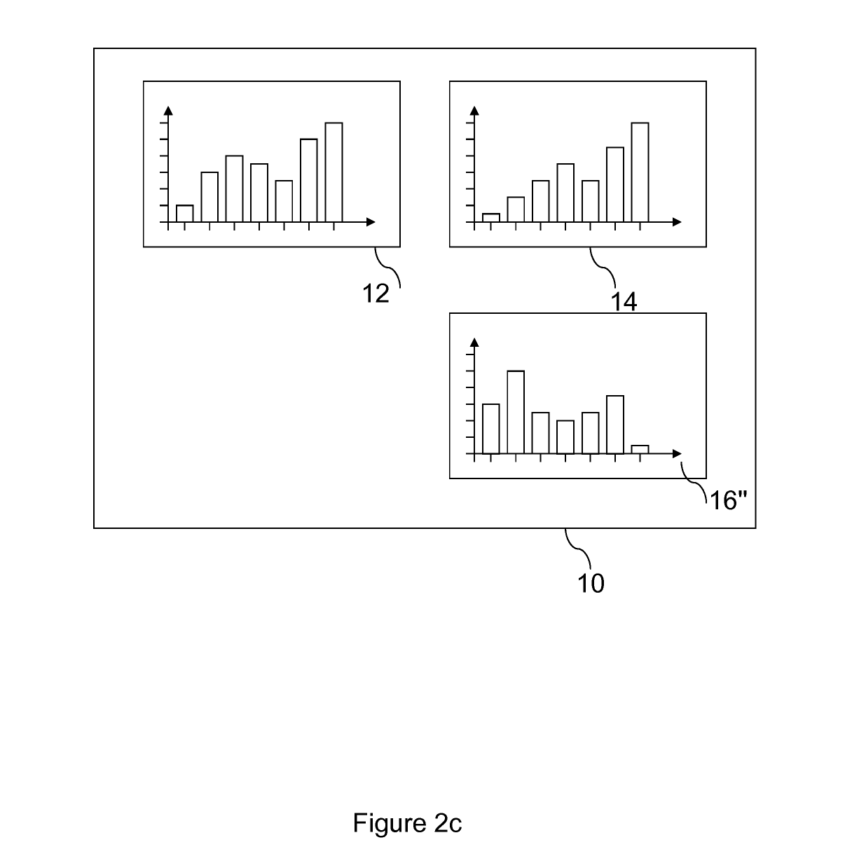

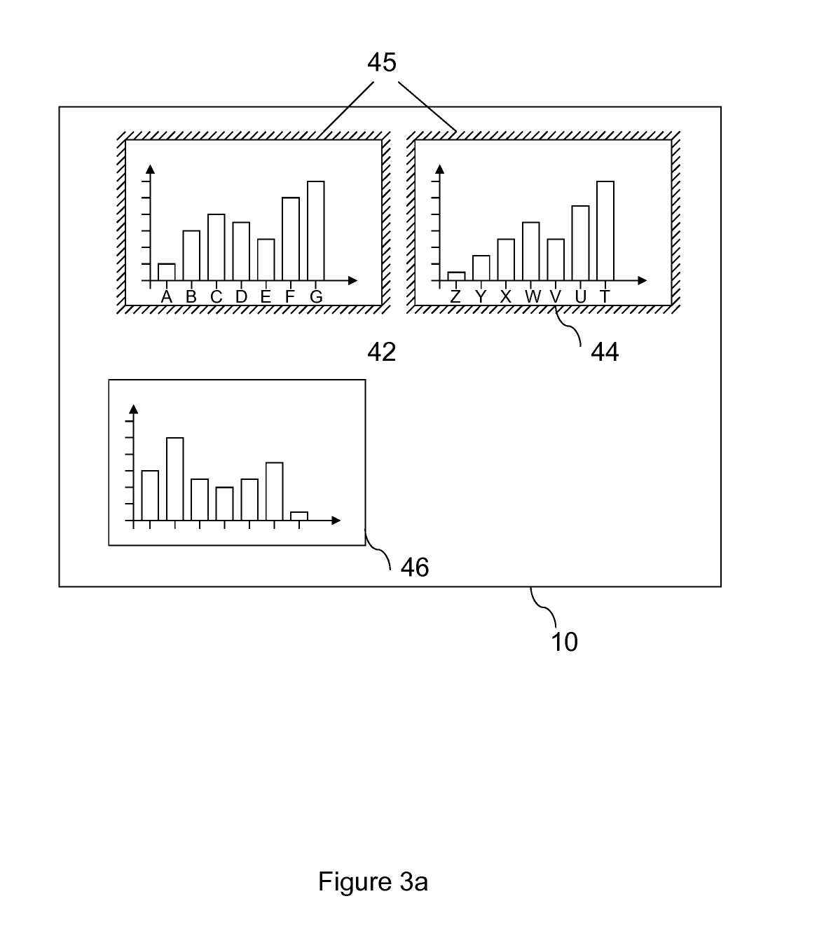

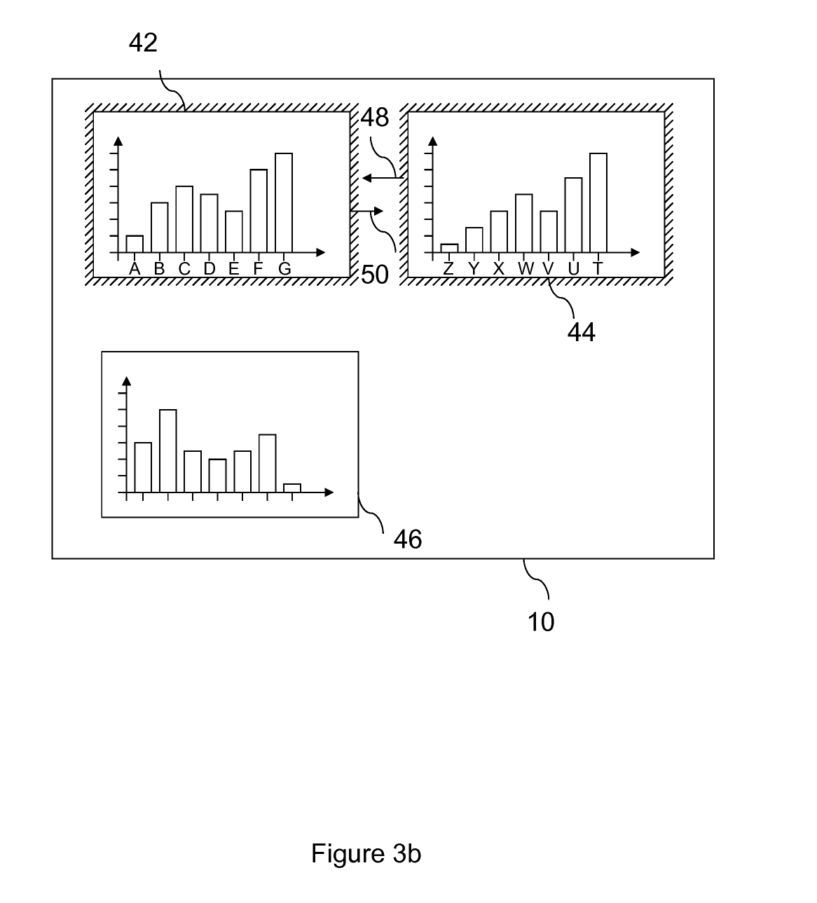

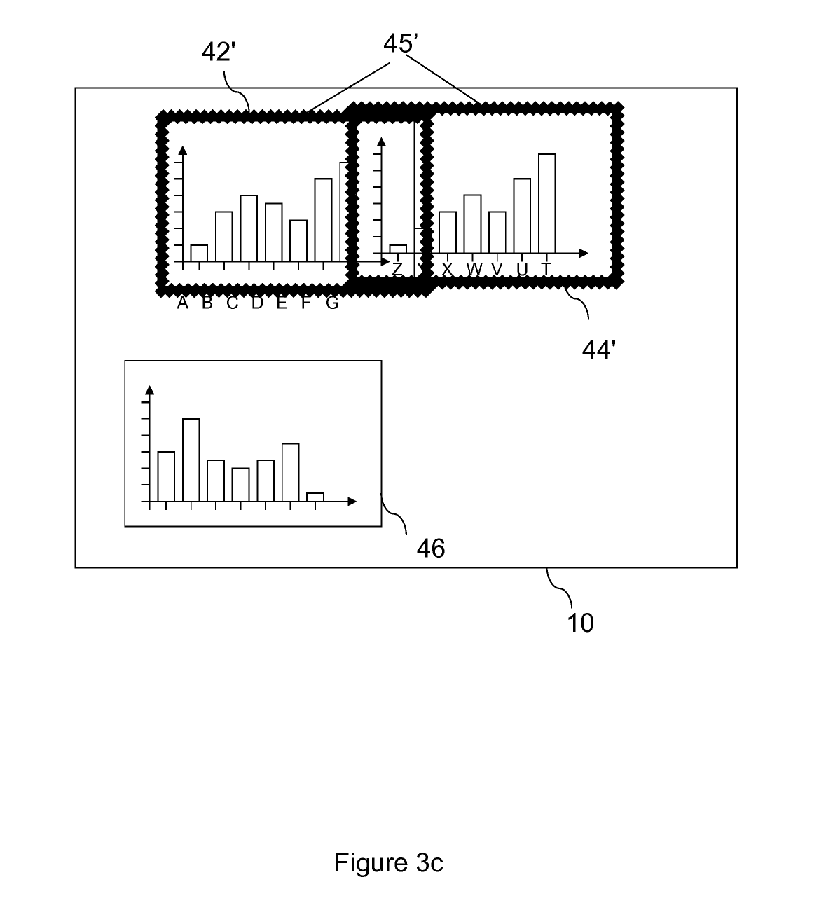

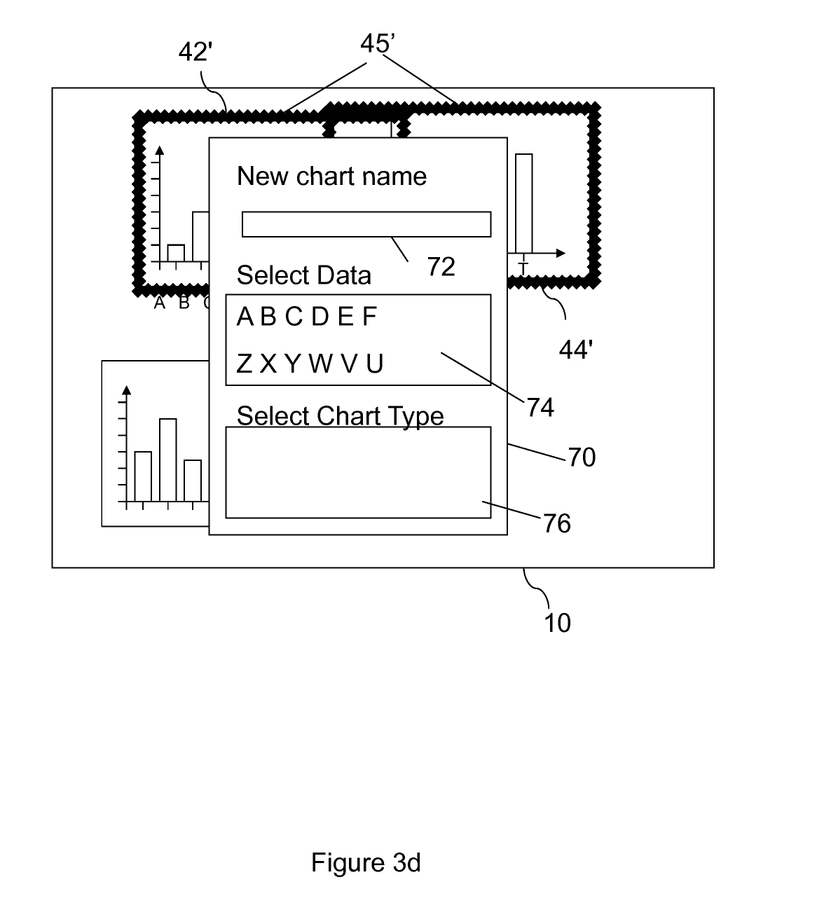

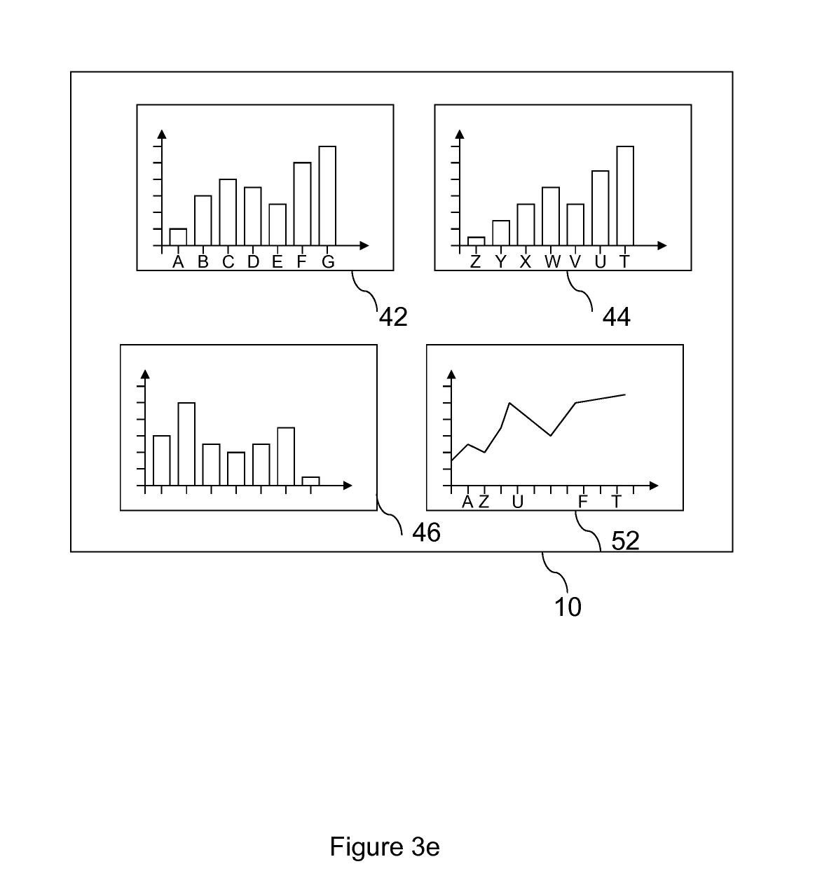

FIG. 2 shows the selection and movement of charts that are displayed on a display 10 and is split in to three steps described in FIGS. 2a, 2b and 2c.

Referring to FIG. 2a the charts 12, 14, 16 that are displayed on the display 10 can be selected. Each chart 12, 14, 16 is selected by initiating a user input, such as by touching the touch screen display 10. Preferably selection of the charts 12, 14, 16 is made by directly touching the touch screen anywhere within the perimeter of the displayed chart 12, 14, 16 on the display 10. The dotted areas 22, 24, 26 show examples of touch locations which result in the selection of each of the charts 12, 14, 16 respectively. Alternatively, selection of the charts 12, 14, 16 is made by touching an area that is associated with the chart 12, 14, 16 but not coincident with it. For example, the area associated with the chart may exceed the displayed area of the chart on the display 10. The area may be within, partially within, or outside the perimeter of the displayed chart. Advantageously, this allows the accuracy with which a chart is selected to be varied according to, for example, user requirements or display restrictions arising from the area of display available.

Alternatively or additionally the charts 12, 14, 16 can be selected by performing an input on the desired chart 12, 14, 16 using a cursor displayed on the display 10, or by performing an input on an area associated with the display (such as an icon representative of the chart, not shown).

FIG. 2b shows conventional movement of a chart 16′ displayed on the display 10 from the position of chart 16 in FIG. 2a in response to a particular user input. The chart 16′ is moved from the position that chart 16 of FIG. 2a is shown to be in using a traced movement of a user input across the screen from dotted area 26 to dotted area 28. The effect of a user selecting the chart 16 by touching the screen, the touch represented by the dotted area 26, and tracing their finger to dotted area 28 is that the chart 16 of FIG. 2a moves from its displayed position to the displayed position of chart 16′ in FIG. 2b. The movement occurs in a direction 30, as displayed on the display 10 and as dictated by the trace detected at the touch screen display 10. Preferably the movement of the chart 16 from its position in FIG. 2a to the position of chart 16′ in FIG. 2b is made by touching the display with a finger and moving it relative to the screen 10 whilst keeping contact with the screen 10 and releasing the finger at the position where chart 16′ is displayed. In further examples a stylus or other implement is used to effect a trace. Preferably, in response to the removal of a finger from the display 10, the chart 16′ is displayed at the position when the finger is removed. In further examples the response occurs upon removal of the implement being used to produce a trace, or the termination of a gesture. Further actions may be initiated in response to the removal of the finger or used object. The chart 16 of FIG. 2a can be moved to any displayable position on the display 10 using the chosen method of user input.

In an example, removal of a finger from the touch screen display 10 causes the chart 16′ of FIG. 2b to be displayed in a different position to where the input selection was terminated. For example, by removal of a finger from the touch screen display 10 at dotted area 28 in FIG. 2b, the processor 17 is configured to align the charts displayed at display 10 in predetermined areas, such as quadrants of the display 10, based on a predefined formula. In FIG. 2c, it is shown that preferably the chart 16″ is aligned in a different quadrant to chart 16 in FIG. 2a. The change in position from chart 16 in FIG. 2a to chart 16″ in FIG. 2c results from the detection of movement of a user input across the screen, which causes the preferred position of alignment of the chart to switch from the bottom left quadrant of the display 10 to the bottom right quadrant of the display 10. Such alignment of charts on display 10 is used to order the charts and make navigation straightforward. The preferred positioning of charts is predetermined in accordance with the display requirements of the apparatus and user. In further examples, charts can be placed anywhere on the display 10 and are not forced to align, thereby providing the user with control of where the charts are displayed.

FIG. 3a shows three charts 42, 44, 46 displayed at display 10. The charts relate to data stored in database 20 and are generated in response to a query in a known manner.

Charts 42 and 44 comprise highlighting 45 which surrounds the outside of both chart 42 and 44. Highlighting 45 is illustrated in FIG. 3a by using short lines surrounding the perimeter of the chart displayed on display 10. The form of highlighting may be altered according to user preference. However the highlighting 45 is preferably provided by displaying a coloured glow (such as an orange glow) around the perimeter of the charts 42, 44.

Highlighting 45 of particular charts is present to indicate that those particular charts have been selected and that the data displayed in those charts is able to be combined to provide a new chart that provides a user with different information to compare than any of the exiting charts in isolation. In an example, the data of chart 42 relates to the sales of a first set of product for cities A to G and the data of chart 44 relates to the sales total sales of a second set of products Z to T.

Chart 46 does not have any highlighting which indicates that it has either not been selected, or if it has been selected, it is not possible for it to be combined with charts 42 and 44. For example the y axis of chart 46 might relate to a quantity so far removed from the total sales depicted in charts 42 and 44 that the data cannot be meaningfully represented alongside total sales data.

Preferably the method of highlighting a chart to indicate that it is associated at least in part with data that can be combined with further data involves highlighting the entire area associated with the chart. Alternatively the area that is highlighted corresponds to, but does not outline, the area that is associated with the chart. Advantageously this allows control over the area that is used to indicate that the chart may be integrated with another chart.

As an alternative to a consistent highlighting 45 (such as an orange glow) the method of highlighting, for example the choice of colour used to highlight a chart, can indicate the amount or type of data that can be sourced and combined upon selection of the chart.

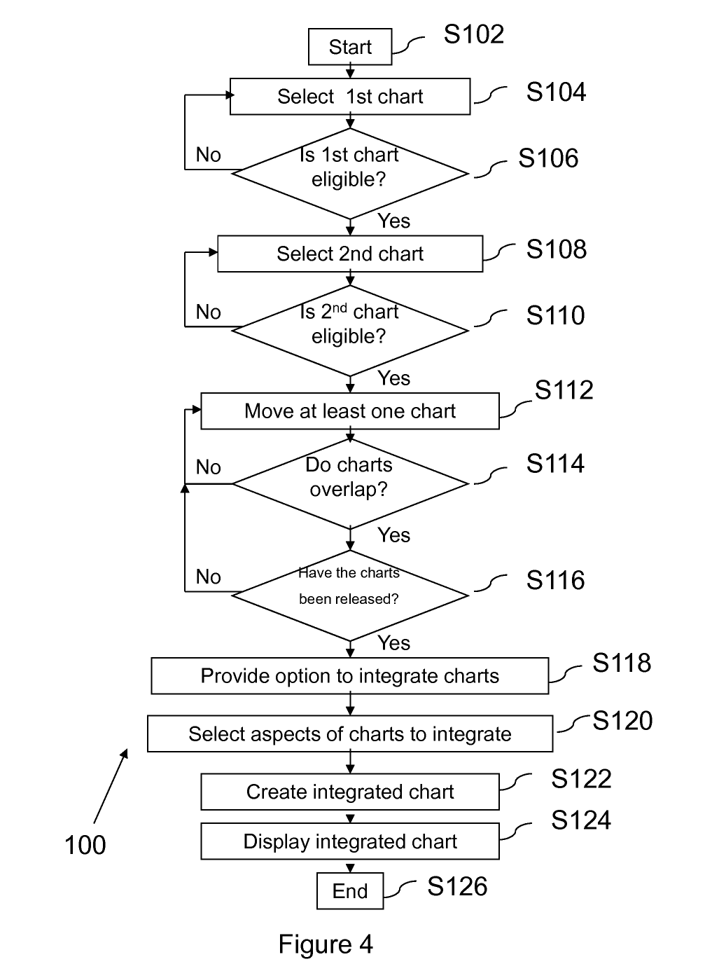

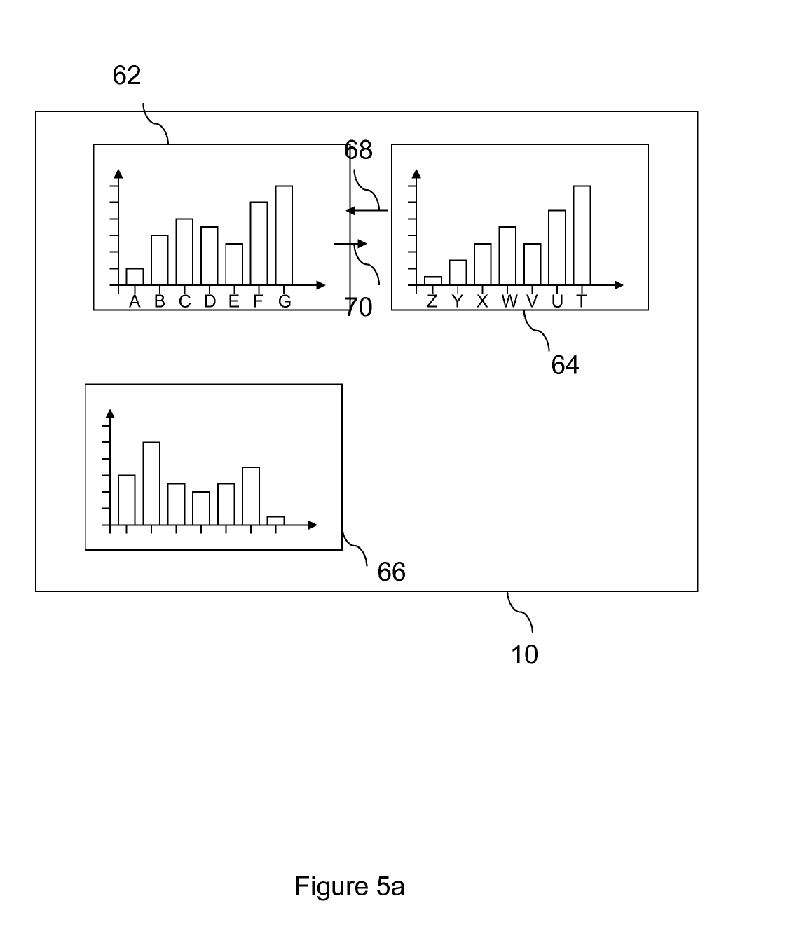

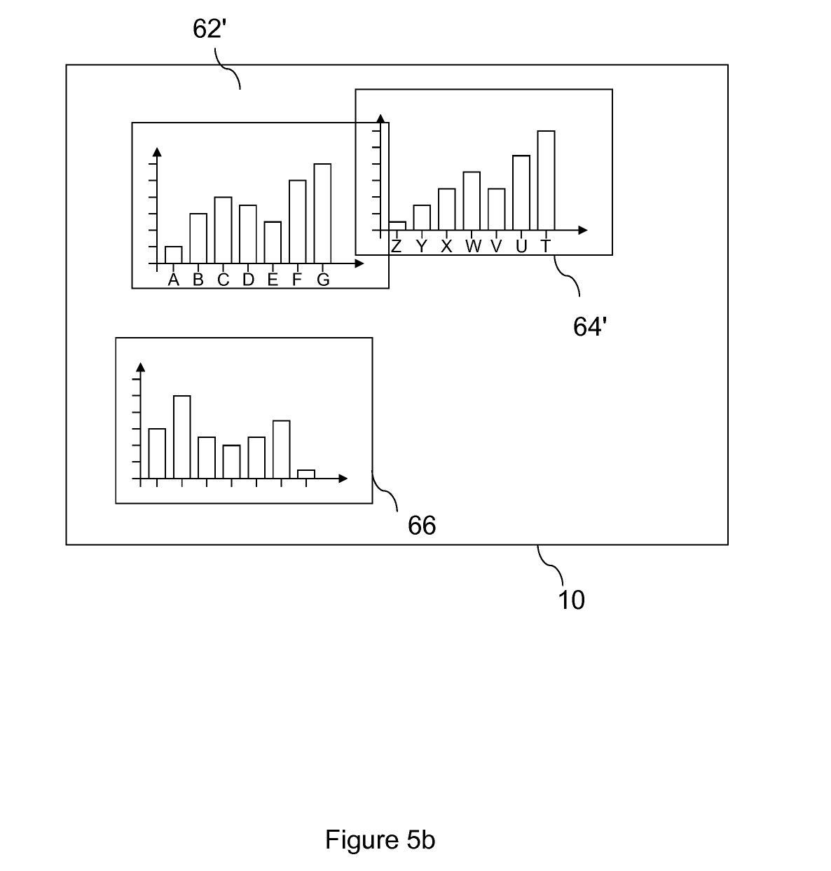

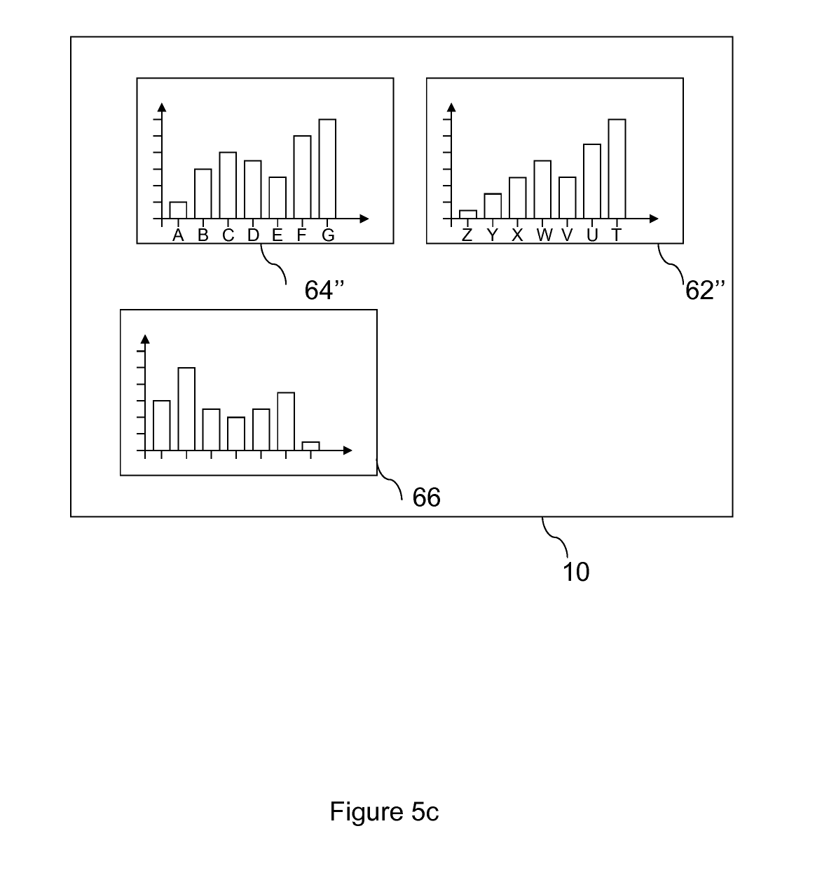

FIG. 3b shows the two selected and highlighted charts 42, 44 in the process of being moved. Shown in FIG. 4b is the direction of movement of each of the selected and highlighted charts 42, 44. Chart 42 is being moved in the direction 50 towards chart 44. Chart 44 is being moved in the direction 48 towards chart 42.

In the example shown, two charts are combined. However, there is no limit to the number of charts that can be combined in order to generate displays of combined data. In further examples, more than two charts are selected, highlighted and combined. In further examples, more than two charts are selected and combined. In the example shown, three charts are shown to be displayed at the display 10. In further examples any number of charts may be displayed at the display 10.

In FIG. 3c the selected charts 42, 44 of FIGS. 4a and 4c are shown to have moved to positions illustrated by charts 42′ and 44′, in response to an input to move the displays in accordance with the method described at step S112 of the flow chart of FIG. 3. The displayed charts 42′ and 44′ are shown to overlap. The overlap of the charts 42′, 44′ has caused a change to highlighting 45′. Preferably the colour of the highlighting around the perimeter of the charts 42′, 44′ is changed such as from an orange to green glow.

The change from the highlighting 45 to highlighting 45′ indicates to a user that if the charts 42, 44 are released into their currently displayed positions, a combined chart will be generated from data form the charts 42 and 44 which have highlighting 45′. The change to the highlighting may occur only after there is an amount of overlapping above a predetermined threshold.

In further examples, any change of colour or method of indicating that the charts are sufficiently overlapped, is used in order to alert the user to the overlap in the charts 42′, 44′. Preferably any overlap of charts 42′, 44′ causes an indication that the charts are sufficiently overlapped. In further examples the charts 42′, 44′ must be overlapped by a predetermined area in order for the indication to be made. In further examples an active area associated with the charts must be overlapped by at least a predetermined area in order for the indication to be made.

In FIG. 3c the overlapping charts are illustrated as transparent in the sense that the portion of the chart 44 lying behind chart 42 can still be seen. Alternatively the charts are opaque so that the overlapping portion of chart 44 that is behind chart 42 is hidden from view.

In FIG. 3d the charts are in the same positions as in FIG. 3c but an additional window 70 is displayed which presents options from a wizard that guides users through the process of combining charts. Window 70 includes a field 72 for entering a new chart name, a chart type section 76 in which a user can select a type of chart (such as line, bar, pie etc) and a data selection section 74 where the user can select which of the data series form charts 42 and 44 should be displayed in a new combined chart.

FIG. 3e illustrates four charts 42, 44, 46, 52 on display 10. Chart 52 results from the combination of chart 42 and chart 44. The charts 42, 44, 46, 52 are configured to align in predetermined areas of the display 10, for example quadrants, in a way that makes the display easy to view for the user, in response to predetermined rules. Such a view may result according to the repositioning of moved charts in relation to a user input. In further examples, the charts do not align according to predetermined rules.

FIG. 4 is a flow chart of a method 100 of manipulating data according to an aspect of the invention. There is shown steps performed by a user and apparatus 9 in order to efficiently select and combine two different sources of data in order to generate a new combination of data and then to display that combined data as a chart.

At step S102 the process 100 begins. The process is initiated by launching a program or application, or by starting a feature of a program or application that is already in use. Charts relating to data stored in a database 20 are presented for display. In further examples, search queries are performed and charts resulting from the performed search query results are selected and displayed at a display 10. This is detailed further in relation to FIG. 4a.

Preferably charts are generated from a search query according to the method disclosed in U.S. application No. 61/708,542 and/or U.S. 2010/0094864.

Once the appropriate charts have been displayed at display 10, the process 100 can move to step S104 or alternatively an additional step is needed first. Steps S104 to S124 can always be possible whenever the application/program is launched and charts are on the display 10. Alternatively these steps which relate to combining charts only occur if the application/program is put into a special chart combining mode. For example the user may be presented with a number of icons (not shown) representing different modes and only after the user selects the icon associated with the chart combining mode (such as by touching the icon on the touch screen display 10) can process 100 move to step S104.

At step S104 a first chart is selected. Preferably the chart is selected by touching the area of the display 10 related to the displayed chart, in a conventional method, as described in relation to FIG. 2. Selection of a chart may cause there to be a visual indicator that the chart has been selected. This could be in the form of highlighting or a coloured glow, but if so, should be a different form (such as a different colour) from highlighting 45 or 45′ which also indicates the eligibility for combining charts. Such a visual indicator may only occur if the chart is associated with at least some data that can be combined with further data to provide an alternative display that provides a user with different information to analyse.

Once a first chart (e.g., chart 42) has been selected at step S104, it is determined at step S106 if the first chart is eligible for combining with at least one of the other displayed charts. (e.g., charts 44 and 46). If the chart is eligible, the process moves to step S108. If the first chart is not eligible, combining process 100 returns to step S104, awaiting the selection of an eligible chart. Even though process 100 has been paused other available user interactions may still be possible, for example the user may be able to move the position of the non-eligible selected chart in the manner shown in FIG. 2. Where there is a special chart combing mode, processes other than 100 can be prevented and the user may be prevented from interacting from any chart (e.g., chart 46) that is not eligible for combing with any other displayed chart.

At step S108 a second chart (e.g., chart 44) is selected in the same manner as the first chart is selected.

At step S110 it is determined whether the second chart is eligible. Rather than determine whether the second chart can be combined with any other displayed chart, it is determined whether it can be combined with the first selected chart. If the two selected charts can be combined, highlighting 45 is displayed around both selected charts and the process 100 moves to step S112. FIG. 3a illustrates an example of step S108 being completed where charts 42 and 44 have been selected. If the second chart is not eligible, the process returns to step S108, awaiting an eligible second chart to be selected.

The method of selecting charts is preferably by use of a touch screen as described in relation to FIG. 2a making use of multi-touch capabilities. Preferably charts are only selected whilst the user has their finger in contact with that chart and the two charts are selected using different fingers. Consequently it is possible to select two charts and therefore perform steps S104 and S108 simultaneously. If the charts are released by the user moving their fingers away from the screen 10 at any point before step S116 then the process returns to step S104. If only one of the two charts is released then the process return to step S108 regardless of whether the released chart was selected first or second, that is if a user were to select chart 42, then chart 44, then release chart 42 and maintain selection of chart 44, then chart 44 would then be treated as the first chart selected and process 100 would await an additional selection.

Step S112 commences when a particular user action is performed and results in movement of at least one of the charts. That user action can be an operation on the touch screen display 10, as previously described in relation to FIG. 2. The movement of at least one of the charts enables the user to move together the displayed charts containing at least some information that they wish to combine in a third display/visual representation of data. In order for the process 100 to move onto step S116 the selected charts must be moved towards each other. Preferably the user moves both charts towards each other in the manner illustrated in FIG. 3b. This action can be instigated by a user using two digits (fingers or a finger and thumb) on the same hand to select the charts (e.g 42 and 44) and pinching those digits towards each other. In a further example a swipe gesture may be used. In further examples the selected charts are moved using a cursor controlled by a mouse, trackball, motion sensor or other method of input. In further examples, only one of the charts 42, 44 is moved and the other chart remains displayed in the same position on the display 10.

At step S114 it is determined whether the movement in step S112 has caused two or more of the charts to overlap. Alternatively, it is determined whether specific areas associated with each of the charts overlap—or whether there has been sufficient overlap. This step is used to determine whether the charts have reached sufficient proximity such that it is indicative of the user's intent to combine the respective sources of data of the two selected charts. If the charts do not overlap (sufficiently), the process returns to step S112, whereby at least one of the charts is moved. If the charts do overlap (sufficiently) at step S114, the highlighting is changed to indicate to the user that (sufficient) overlap has occurred. FIG. 3c illustrates the completion of step S114 with highlighting 45 changing to highlighting 45′. Preferably an orange glow changes to a green glow. The process 100 then moves onto to step S116.

At step S116 it is determined whether the charts have been released. Release of the charts can initiated by removal of at least one and preferably both digits from the touch screen display 10 and termination of the detection of the gesture upon the touch screen display 10. In further examples other gestures or operations are used to indicate that the selected charts are to be used to generate data from the different sources of data and to generate a display of that data.

If the charts have not been released they may continue to be moved as displayed at the display 10, in response to the user input, and the process continues by returning to step S112 or S114. Upon release of the charts, the process moves to step S118. In further examples in response to a predetermined gesture or operation, or termination of a gesture or operation, the process moves to step S118.

The change in highlighting such as the change to a green glow which occurs following step S114 allows the user to know that release of the charts will result in the process moving to step S118 so that the charts can be combined. If the charts are released prior to the determination of (sufficient) overlap at step S116 the process will return to step S104. Consequently the user can determined whether release will lead to step S118 and combining of charts or to an earlier step based on the highlighting 45/45′ for example whether the glow is orange or green. The user is therefore able to control when combination occurs and is able to readily and rapidly know when release will result in combination.

At step S118 an option to integrate data from the selected charts is provided. For example, if the first highlighted chart relates to the number of sales of a product in a first city and the second highlighted chart relates to the number of sales of the product in a second city, the option to combine data may be to show the number of sales by city, or the total number of sales across cities. Preferably a display showing the selectable data that can be combined is shown (as illustrated by section 74 in FIG. 4d) and selected in response to a user input. In a further example if there is only one possible combination of data from the charts, the process can move directly from step S116 to step S122. In a further example, the combination of data to be displayed computed by the processor 17 and is generated by the processor 17 automatically in response to a predefined set of rules that determine the user's likely preference. The process moves from step S116 directly to step S122 in that case.

Once the options to integrate data from the selected charts is provided at step S118, the process moves to step S120, where the user selects the aspects of the data that they wish integrate/merge/combine. Preferably a list of options is shown in a new window displayed at the display 10. In other examples the options to be selected are chosen from any selectable form of user input. Preferably the user is requested to enter a new name for the chart that is to be created. In further examples the chart is created without a request for a new chart name being made.

FIG. 3d illustrates an example of steps S118 and S120. In the example, release of overlapping charts prompts a chart combining wizard to be run and window 70 to be displayed. The wizard can guide a user through the process of step S120. In FIG. 3d the user is able to select using section 7 which data from charts 42 and 44 to use for creating a new chart. The user is also able to select what type of chart will be created using section 76 and is able to give a name to the chart using field 72. The new name may be for display purposes and/or as a file reference.

The process then moves to step S122, where the chart to be displayed is computed and generated by the processor 17, using data from the database 20, whereby the data is associated at least in part with the highlighted charts. The generated data may then be stored in temporary memory or stored in a database.

The process then moves to step S124, whereby the integrated data selected by the user is displayed in another chart on display 10 as illustrated in FIG. 4d with new chart 52. In a further example, the newly generated chart created at step S122 replaces the source charts that were selected so that they (e.g., charts 42 and 44 are removed from the display).

Once an integrated chart has been displayed at step S124, the process moves to step S126, where the process ends. A new process may be started in order to integrate data, based on the user's requirements. Further integration of data may include the use of a chart generated using the process of the flow chart of FIG. 4.

Whilst in the examples illustrated above only two charts are selected, the invention can also be when any number of charts are selected and moved/pinched together. The user can also select more than two charts but release the charts when only two are overlapping. If this is the case only the highlighting 45 of the overlapping charts will change (e.g., turn from orange to green) and only those overlapping charts will be combined.

FIGS. 5a, 5b and 5c show the stages of movement and selection of charts 62, 64 that are not eligible for combining/integration. FIG. 5a shows three charts 62, 64, 66 that are displayed at a touch screen display 10. Chart 62 is moved in the direction 70 indicated by the arrow, towards chart 64, which is moved in the direction 68 indicated by the arrow, towards chart 62. The selection of the charts is made according to the methods previously described and the movement of the charts occurs in response to a user input. In FIG. 5b the charts 62′, 64′ are shown to overlap. There is no indication that the overlap will result in a further chart to be created. Upon termination of the detection of the input that is used to move the charts, or in response to another or different input, in accordance with an aspect of the invention, the charts are left in the positions shown in FIG. 5b. In a further example, the charts 62′ and 64′ of FIG. 5b are moved from the position where they are displayed on display 10 in accordance with predetermined rules designed to align charts neatly on display 10. FIG. 5c shows charts 62″ and 64″ in different positions to charts 62 and 64 of FIGS. 5a and 62′ and 64′ of FIG. 5b.

Alternatively, the selection and subsequent movement of charts leads to the option to integrate data from the at least partly different sources of data associated with them, even in the absence of charts being highlighted. This occurs when an area associated with each of the charts displayed on the display 10 overlaps.

1. A computer implemented method comprising the steps of:
detecting a user selection of a plurality of visual representations of data associated with at least partially different sources of data;
enabling a user to move the location of at least one of the selected visual representation of data on a display, and thereby to move an active area associated with it,
generating a new visual representation of data; and
displaying the new visual representation of data,
wherein:
the step of generating is performed after a user has moved at least one of the selected visual representations of data, and an active area associated with it, so that the moved active area overlaps an active area associated with another of the selected visual representations,
the step of generating is at least partially in response to the overlap of active areas of selected visual representations, and
the new visual representation of data is based on/represents data represented/displayed in the selected visual representations of data which have overlapping active areas.

2. The method according to claim 1, wherein the active areas associated with the selected visual representations of data become active in response to the user selection.

3. The method according to claim 1, wherein the user selection of a plurality of visual representations of data associated with at least partially different sources of data is simultaneous.

4. The method according to claim 1, wherein the step of generating is performed after overlap of areas is greater than a predetermined value.

5. The method according to claim 1, comprising the step of displaying a first visual indicator which indicates to a user that the selected plurality of visual representations display/represent data which can be used together to generate a new visual representation.

6. The method according to claim 5, wherein the first indicator comprises a colour on or surrounding the selected or overlapping visual representations and preferably the first and second indicators comprise different colours.

7. The method according claim 5, comprising the step of displaying a second visual indicator which indicates to a user that at least two of the active areas of the selected plurality of visual representations overlap or overlap of areas is greater than a predetermined value.

8. The method according to claim 7, wherein the first and second indicators are different.

9. The method according to claim 8, wherein the second indicator replaces display of the first when overlap occurs.

10. The method according to claim 7, wherein the second visual indicator also indicates that the selected visual representations with overlapping active areas display/represent data which can be used together to generate a new visual representation.

11. The method according to claim 7, wherein:
the second visual indicator also indicates that the selected visual representations with overlapping active areas display/represent data which can be used together to generate a new visual representation,
the step of generating is at least partially in response to detection of termination of user selection of representations with overlapping active areas,
the detection of termination prompts a user to
select data represented/displayed in the selected visual representations of data which have overlapping active areas,
to base the new visual representation on/to represent in the new visual representation, wherein release of fingers from a touch screen (or other termination of selection) when the second indicator is displayed causes the prompt to a user to select data from the overlapping representations, and user selection of the data from the overlapping representations causes the generating step to initiate.

12. The method according to claim 7, wherein the first and second indicator comprises a colour on or surrounding the selected or overlapping visual representations and preferably the first and second indicators comprise different colours.

13. The method according to claim 7, wherein the second indicator comprises a colour on or surrounding the selected or overlapping visual representations and preferably the first and second indicators comprise different colours.

14. The method according to claim 1, wherein the step of generating is at least partially in response to detection of termination of user selection of representations with overlapping active areas.

15. The method according to claim 14, wherein the detection of termination prompts a user to:
select data represented/displayed in the selected visual representations of data which have overlapping active areas,
to base the new visual representation on/to represent in the new visual representation.

16. The method according to claim 1, wherein the new visual representation of data is generated/displayed upon detection of a second user selection.

17. The method according claim 1, wherein the user selection is made on a touch-sensitive screen.

18. The method according to claim 1, wherein the user selection is made using a multi-finger gesture.

19. The method according to claim 18, wherein the user is enabled to move selected representations towards each other using a pinch gesture.

20. The method according to claim 19, wherein the generating step is at least partially in response to a user pinching representations together so that their active areas overlap.

21. The method according to claim 1, wherein at least some and preferably all of the visual representations are charts.

22. A medium comprising computer readable instructions which when executed on computing apparatus cause the apparatus to perform a method comprising the steps of:
detecting a user selection of a plurality of visual representations of data associated with at least partially different sources of data;
enabling a user to move the location of at least one of the selected visual representation of data on a display, and thereby to move an active area associated with it;
generating a new visual representation of data; and
displaying the new a new visual representation of data,
wherein:
the step of generating is performed after a user has moved at least one of the selected visual representations of data, and an active area associated with it, so that the moved active area overlaps an active area associated with another of the selected visual representations,
the step of generating is at least partially in response to the overlap of active areas of selected visual representations, and
the new visual representation of data is based on/represents data represented/displayed in the selected visual representations of data which have overlapping active areas.

23. The medium of claim 22, comprising a non-transient storage medium or a transient medium such as a signal.

24. Computing apparatus comprising a processor and a memory, wherein the processor is configured to implement the steps of:
detecting a user selection of a plurality of visual representations of data associated with at least partially different sources of data;
enabling a user to move the location of at least one of the selected visual representation of data on a display, and thereby to move an active area associated with it,
generating a new visual representation of data; and
displaying the new a new visual representation of data,
wherein:
the step of generating is performed after a user has moved at least one of the selected visual representations of data, and an active area associated with it, so that the moved active area overlaps an active area associated with another of the selected visual representations,
the step of generating is at least partially in response to the overlap of active areas of selected visual representations, and
the new visual representation of data is based on/represents data represented/displayed in the selected visual representations of data which have overlapping active areas.
